(19) United States
(12) Patent Application Publication
(10) Pub. No.: US 2001/0047327 A1
(43) Pub. Date: Nov. 29, 2001

(54) System and method for calculating mortgage loan balance to appraisal value ratio

(76) Inventor: Michael T. Courtney, Garland, TX (US)

Correspondence Address: Richard C. Litman, LITMAN LAW OFFICES, LTD., P.O. Box 15035, Arlington, VA, 22215, US

(21) Appl. No.: 09/828,933

(22) Filed: Apr. 10, 2001

Related U.S. Application Data
(60) Provisional application No. 60/195,330, filed on Apr. 10, 2000.

(51) Int. Cl. G06F 17/60

(52) U.S. Cl. 705/38; 705/42

(57) ABSTRACT

A computerized system and method for calculating a mortgage loan balance to appraisal value ratio for a given property. Data relating to a mortgage loan balance and appraisal value ratio is input into a computerized system. The data is then used by the computerized system to calculate a mortgage loan balance to appraisal value ratio for the property. A set of geographical coordinates is then entered into the system for defining the geographical location of the property. A computer listing of recorded properties located within a predefined radius of the property is then generated. A current property listing generated by a multiple listing service and comparative market analysis is also obtained and entered into the system.

### CROSS-REFERENCE TO RELATED APPLICATION

This application claims the benefit of U.S. Provisional Patent Application Serial No. 60/195,330, filed Apr. 10, 2000.

### BACKGROUND OF THE INVENTION

1. Field of the Invention

The present invention relates generally to a system and method for calculating mortgage loan balance to appraisal value ratios for property.

2. Description of Related Art

The appraised value of a real estate parcel, or property, comprises an informed and educated estimate of the full market value of the property on a specified date. A property's appraised value is of great importance in many types of real estate transactions, including sales and loans.

Conventionally, appraised value is determined by a professional appraiser using both objective and subjective factors. One disadvantage of such a method is the difficulty in ensuring that the appraiser conducts a neutral, unbiased analysis in arriving at the appraised value. This difficulty is often compounded by the fact that the appraiser may be retained and paid by an interested party in the contemplated transaction, such as a lender, mortgage broker, buyer, or seller.

In order to reduce bias and provide more accurate appraisals, statistical techniques may be used to obtain an independent, consistent, mathematically derived estimate of a property's value. Traditional statistical techniques, such as multiple linear regression and logistic regression, have been tried, but such techniques typically suffer from a number of deficiencies. One deficiency is the inability of traditional regression models to capture complex behavior in predictive variables resulting from non-linearities and interactions among predictor variables. In addition, traditional regression models do not adapt well to changing trends in the data, so that automated model redevelopment is difficult to implement.

One example of the difficulty of applying a regression model to appraisal problems is the uncertainty as to the optimal temporal and geographical sample size for model development. A model developed using all homes in one square city block might theoretically be an effective predictor for that particular neighborhood, but it may not be possible to develop such a model with sufficient stability and reliability, due to the relatively small sample size. On the other hand, a model developed using all homes sold in the United States in the past month might have a sufficiently large sample size, but might be unable to capture local, neighborhood characteristics to provide an accurate appraisal. Thus, a significant deficiency of traditional regression modeling techniques when applied to real estate appraisals is the inability to successfully model neighborhood characteristics while including a sufficiently large sample size to develop a robust, stable statistical model.

Several patents are illustrative of well known computer-based financial systems. U.S. Pat. No. 5,361,201 issued on Nov. 1, 1994 to Allen Jost et al. describes an automated real estate appraisal system and method that generates estimates of real estate value using a predictive model such as neural network.

U.S. Pat. No. 5,606,496 issued on Feb. 25, 1997 to Richard J. D'Agostino describes a personal financial assistant computer system and method that includes customer terminals at financial institution branch offices or other locations. Each customer terminal stores financial information for the particular financial services (such as insurance, annuities, bonds, mortgages or loans) sold at that terminal.

U.S. Pat. No. 5,673,402 issued on Sep. 30, 1997 to Ronald D. Ryan describes a computerized system for initiating, processing, preparing, storing, and transmitting illustrations of life insurance in conjunction with a mortgage, the illustrations being devoid of a cost containment clause.

U.S. Pat. No. 5,689,650 issued on Nov. 18, 1997 to Glenn B. McClelland et al. describes a CRA apparatus compiles investor needs for CRA qualified assets, creates portfolios of assets that would be recognized by regulatory agencies as meeting the requirements of the CRA and allocates CRA credits separately from the financial return of the portfolio of assets.

U.S. Pat. No. 5,680,305 issued on Oct. 21, 1997 to Mahlon Apgar, IV. describes systems and methods for providing objective evaluations of a business entity's real estate situation and condition for use by customers including (but not limited to) the business entity. Information is processed to determine indicators of amount, price, area, grade, and risk; and those indicators are combined to provide a total score.

U.S. Pat. No. 5,832,461 issued on Nov. 3, 1998 to Tomas Leon et al. describes a system and method for investment management that includes a means to adjust deposit and loan accounts for inflation.

However, none of the above-mentioned inventions describe a computerized apparatus for monitoring mortgage loan-to-value ratios. Moreover, none of above inventions describes a method for monitoring mortgage loan-to-value ratios without conducting certified home appraisals. Such information would be something that would be desired by the marketplace and be in great demand.

None of the above inventions and patents, taken either singly or in combination, is seen to describe the instant invention as claimed.

### SUMMARY OF THE INVENTION

The present invention is a computerized system and method for calculating a mortgage loan balance to appraisal value ratio for a given property. Data relating to a mortgage loan balance and appraisal value ratio is input into a computerized system. The data is then used by the computerized system to calculate a mortgage loan balance to appraisal value ratio for the property. A set of geographical coordinates is then entered into the system for defining the geographical location of the property. A computer listing of recorded properties located within a predefined radius of the property is then generated. A current property listing generated by a multiple listing service and comparative market analysis is also obtained and entered into the system. A current mortgage loan balance and appraisal value ratio report is then produced.

Accordingly, it is a principal object of the invention to provide a system and method for calculating the mortgage loan balance to appraisal value ratio for a given mortgaged property.

It is another object of the invention to provide a system and method for calculating and monitoring the mortgage loan balance to appraisal value ratio for mortgaged real property without requiring the services of a certified appraisal consultant.

It is another object of the invention to monitor the changing mortgage loan balance to appraisal ratio of a mortgaged property so a mortgage banker knows when it is time to stop charging the owner for private mortgage insurance (PMI).

It is another object of the invention to monitor changing appraisal values for a property using the current system and method.

It is an object of the invention to provide a computerized system and method for calculating mortgage loan balances to appraisal value ratios for the purposes described which is inexpensive, dependable, less labor intensive, and fully effective in accomplishing its intended purposes.

These and other objects of the present invention will become readily apparent upon further review of the following specification and drawings.

### BRIEF DESCRIPTION OF THE DRAWINGS

FIG. 1 is an overview of a system for calculating a mortgage loan balance and appraisal value ratio for a mortgaged property, according to the present invention.

FIG. 2 is a flow chart of an overall method for calculating a mortgage loan balance and appraisal value ratio for a mortgaged property, according to the present invention.

FIG. 3 is an illustration of a first computer interface screen for enabling a user to enter appraisal value information into the present system.

FIG. 4 is an illustration of a second computer interface screen for enabling a user to enter mortgage loan balance information into the present system.

FIG. 5 is an illustration of a third computer interface screen for enabling a user to enter homeowner information into the present system.

FIG. 6 is an illustration of a fourth computer interface screen for enabling a user to enter multiple listing service and comparative market analysis (MLS/CMA) information into the present system.

FIG. 7 is an illustration of a set of map, page and grid coordinates for defining a geographical location for a property, according to the present invention.

FIG. 8 is an illustration of comparison properties (or comps) falling within a predefined radius of a particular property.

Similar reference characters denote corresponding features consistently throughout the attached drawings.

### DETAILED DESCRIPTION OF THE PREFERRED EMBODIMENTS

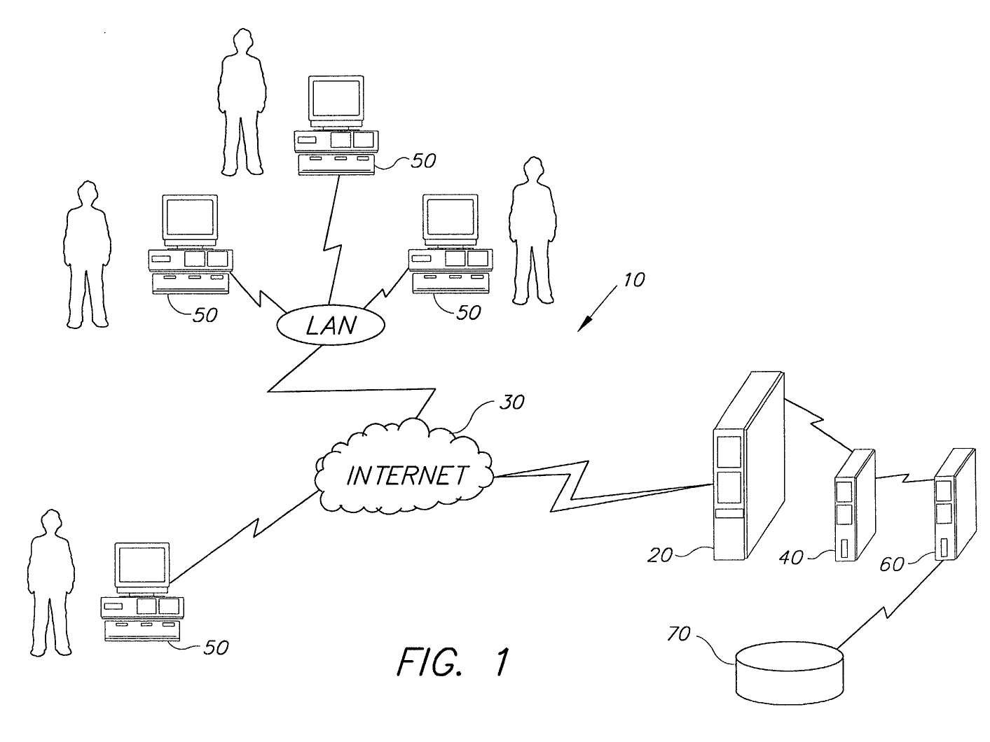

The present invention is a system 10 and overall method 100 for calculating a mortgage loan balance to appraisal value ratio for a given property. This system 10 and method 100 is used by real estate professionals to determine an accurate appraisal value for a given property, and to monitor the need for private mortgage insurance. FIG. 1 is a computerized system 10 overview for calculating a mortgage loan balance to appraisal value ratio according to the present invention.

The system 10 comprises a firewall 20 which is used to protect the system 10 against external threats coming from the Internet 30, a Web server 40 that is accessed by a plurality of client personal computers 50 (PC) via the Internet 30, a database server 60, that is networked together with the firewall 20 and Web server 40, to store information relating to calculating the mortgage loan balance to appraisal value ratio, a data repository 70 used to store data that is received from the database server 60 and the Web server 40 and a software means for generating a plurality of Web page interfaces on the Web server 40 that clients use to enter and calculate the information relating to the mortgage loan balance to appraisal value ratio. Note that the data repository 70 can be a database 72 or a mainframe computer 74.

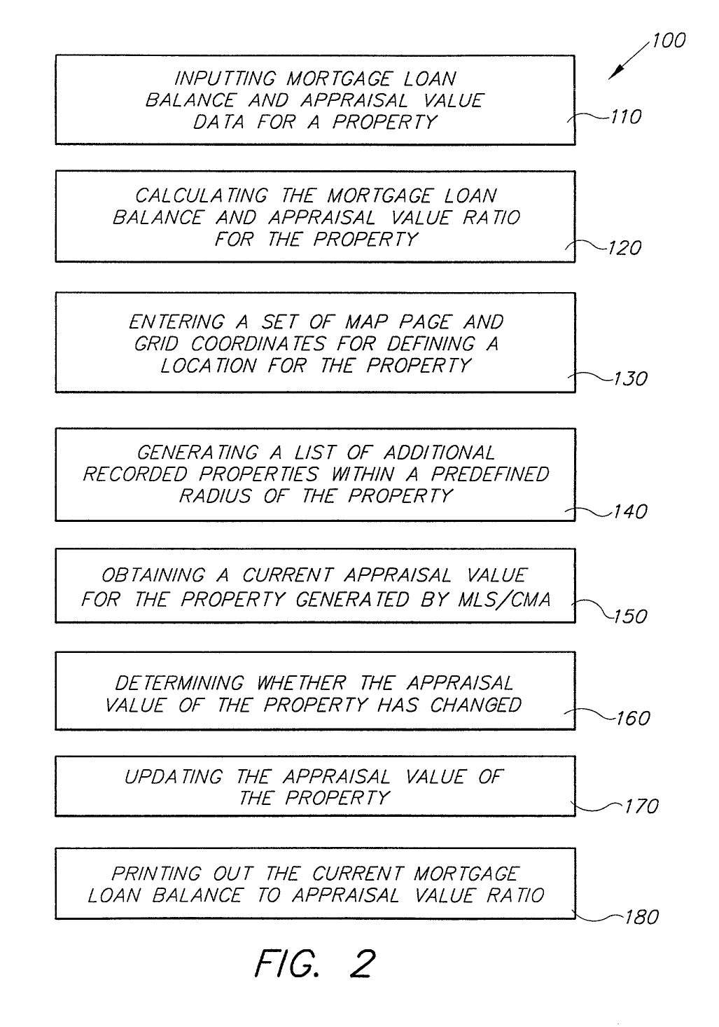

An overall method 100 for calculating a mortgage loan balance to appraisal value ratio for a property, is shown in FIG. 2. The overall method 100 comprises the steps of inputting key mortgage loan balance and appraisal value data for the property 110, calculating the mortgage loan balance and appraisal value ratio for the property 120, entering a set of map, page and grid coordinates for defining a location for the property 130, generating a list of additional recorded properties within a predefined radius of the property 140, obtaining a current appraisal value for the property generated by multiple listing service and comparative market analysis (MLS/CMA) 150, determining whether the appraisal value of the property has changed 160, updating the appraisal value of the property 170 and printing out a current mortgage loan balance to appraisal value ratio report 180. Further details relating to a preferred method 100 for using the system 10 will now be described.

The first step of the overall method 100 is to input mortgage loan balance and appraisal value data for a property 110. Here, a user 80, who is typically a real estate professional such as a realtor, appraiser, mortgage consultant or mortgage banker, is prompted to enter the appraisal value data for the property, such as the number of bedrooms, the number of stories, the number of bathrooms, the number of living areas, the number of garages, the number of swimming pools, the number of fireplaces, the total number of square feet and any amenities and comments regarding the property.

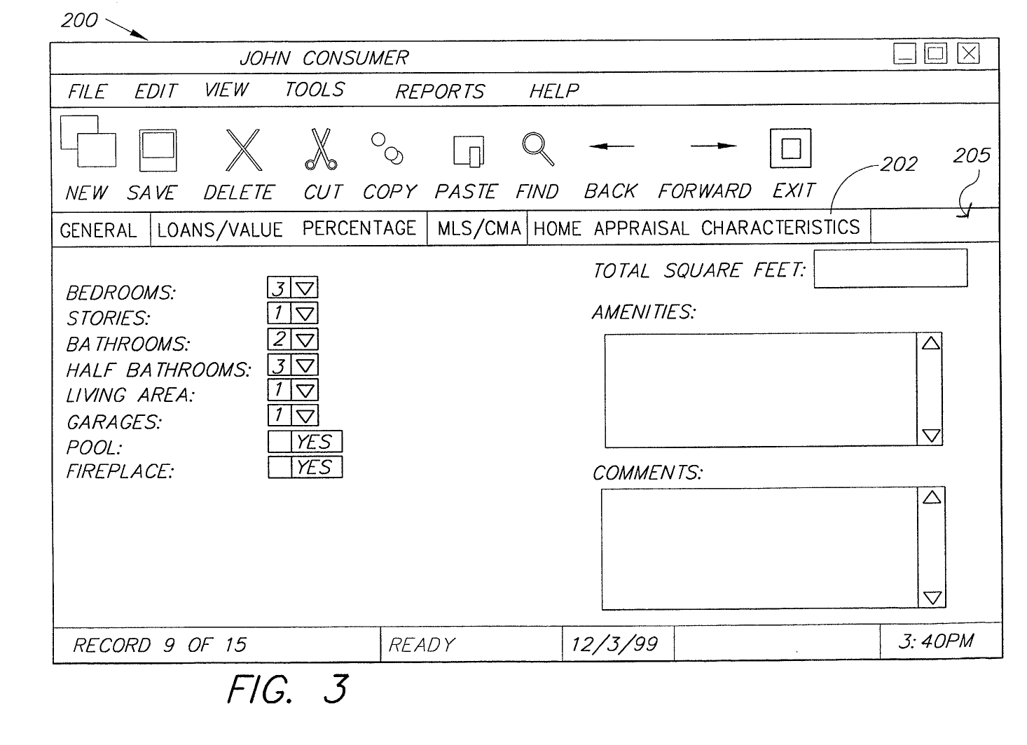

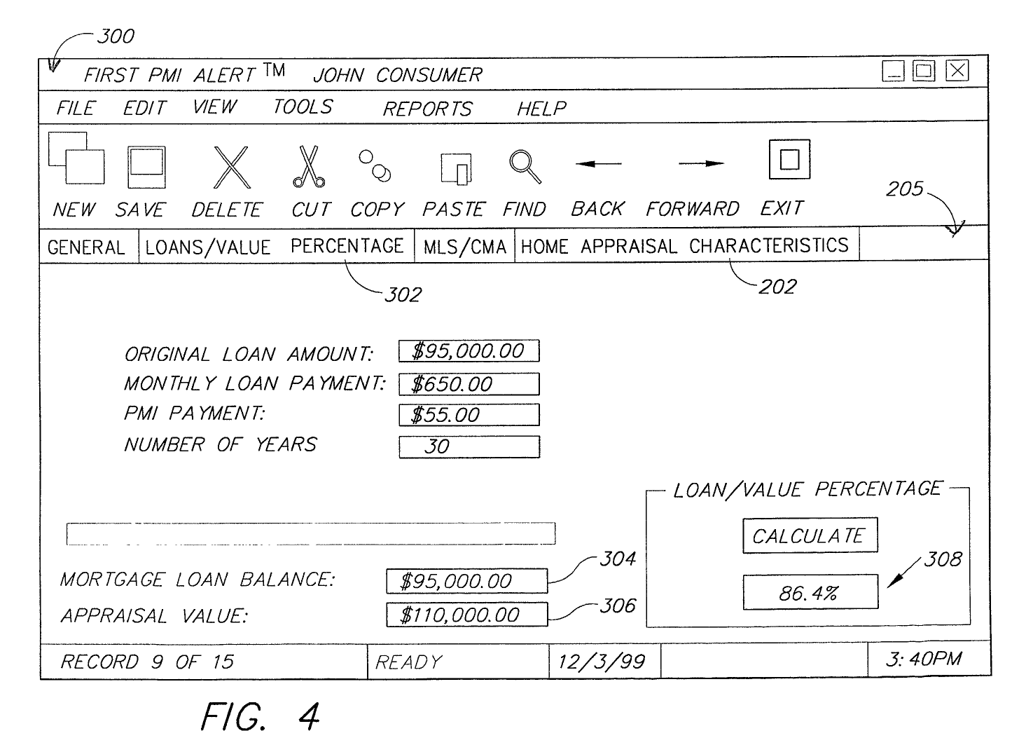

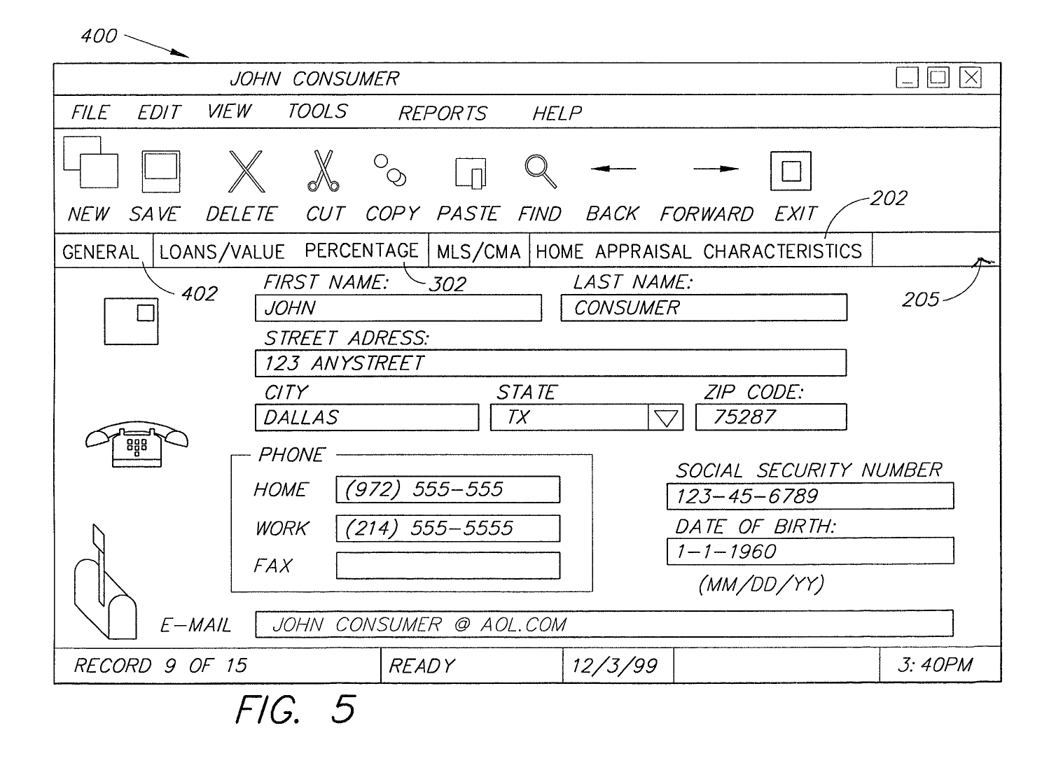

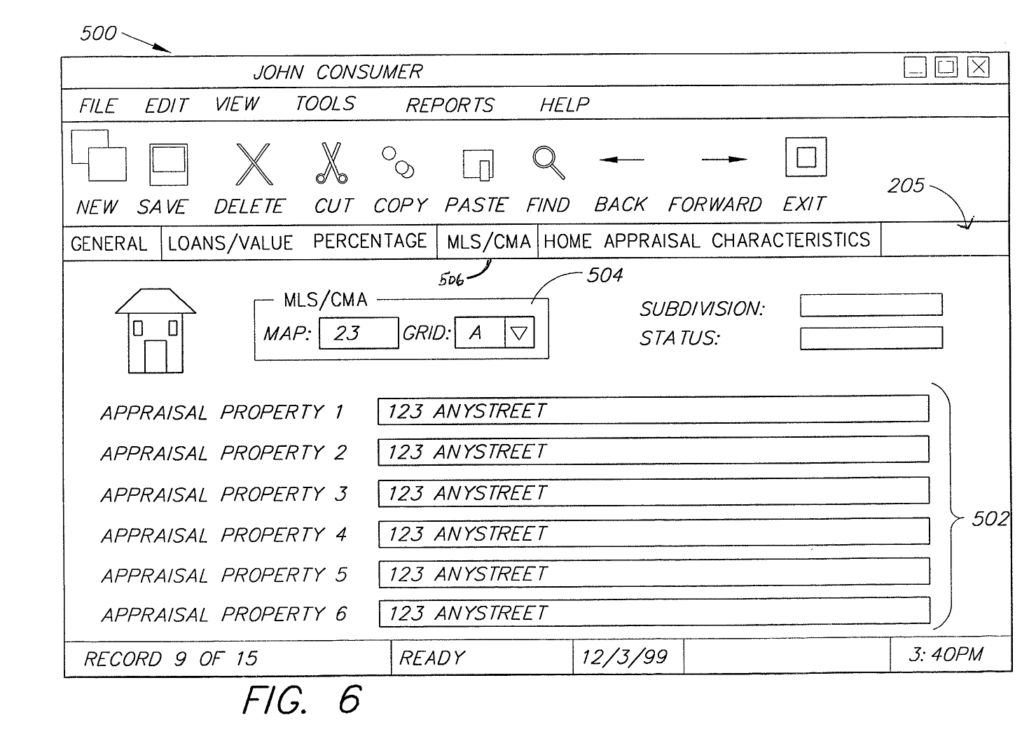

This information is needed to calculate an appraisal value and is entered at the computer screen interface 200 depicted in FIG. 3. This information is accessed by clicking on the “Home Appraisal Characteristics” 202 portion of the selection bar 205 located on FIG. 3, FIG. 4, FIG. 5 and FIG. 6.

FIG. 4 shows a second computer interface 300 for mortgaged loan balance data for a property, comprising the original loan amount, the monthly loan payment, the private mortgage insurance payment (PMI) payment, the length of the mortgage, the mortgage loan balance, the current home appraised value and the mortgage loan balance to appraisal value ratio. This interface is accessed by clicking “Loans/Value Percentage,” portion 302 of the selection bar 205. The most important information contained in FIG. 4 is the “Mortgage Loan Balance” entry 304 and the “Appraisal Value” entry 306. The Mortgage Loan Balance 304 and Appraisal Value ratio 308 is calculated by simply dividing the Mortgage Loan Balance 304 by the Appraisal Value 306.

The Mortgage Loan Balance 304 is easy to obtain from a homeowner's mortgage lender. If the homeowner has a newly ordered certified appraisal that was required by his/her mortgage lender, then the value of the appraisal may simply be keyed into the “Appraisal Value” 306 field. However, if the homeowner does not have a new certified appraisal, then he/she will need to track applicable comparative market analysis and multiple listing service (CMA/MLS) property values or “comps.”, which are discussed later in this application.

FIG. 5 shows a third computer interface 400, which is used for prompting a user 80 to input basic information relating to the owner of the property. This interface 400 is accessed by clicking the “General” portion 402 of the selection bar 205. This information includes the property owner's first name, last name, street address, city, state, zip code, home telephone number, work telephone number, social security number, date of birth and e-mail address and can be easily entered from this interface 400.

FIG. 6 shows a fourth computer interface 500 for prompting a user 80 for information needed to calculate a current appraisal value. This interface 500 is accessed by clicking the “MLS/CMA” portion 506 of the selection bar 205. The first step in establishing an appraisal value of a property is to produce a listing of properties recorded in an earlier MLS/CMA used for appraising a designated property. Up to 6 appraisal properties are entered that must be situated within a 2.5 mile radius of the property being analyzed. The system 10 serves to alert an owner when one or more of the original appraisal properties or “comps” have changed, thereby alerting the owner when the loan/value percentage has changed.

In the case of a new home loan, a user 80 may simply enter in the MLS/CMA properties from a newly ordered certified appraisal that a mortgage lender requires. In the case of a new home loan, a user 80 may enter in the most recent MLS/CMA properties off an applicable MLS/CMA system. The MLS/CMA Properties field 504 will flag a user 80 when its time to compare original MLS/CMA comparative properties to any new MLS/CMA properties that may replace some or all of the original MLS/CMA comparative properties.

The second step of the preferred method 100 involves calculating the mortgage loan balance and appraisal value ratio for the property 120. Here, the loan to value function 102 uses the data entered in FIG. 4 to calculate a loan to value ratio for the property. In particular, the system 10 uses the data entered in the “Mortgage Loan Balance” field 304 and the “Appraisal Value” field 306 of the Loan/Value Percentage window 308 to calculate a loan to value ratio for a property. Preferably, these two fields are updated on a periodic basis (e.g., a monthly, quarterly, or annual basis) for enabling an owner to track the loan to value ratio for a particular property, which has an ever-changing value.

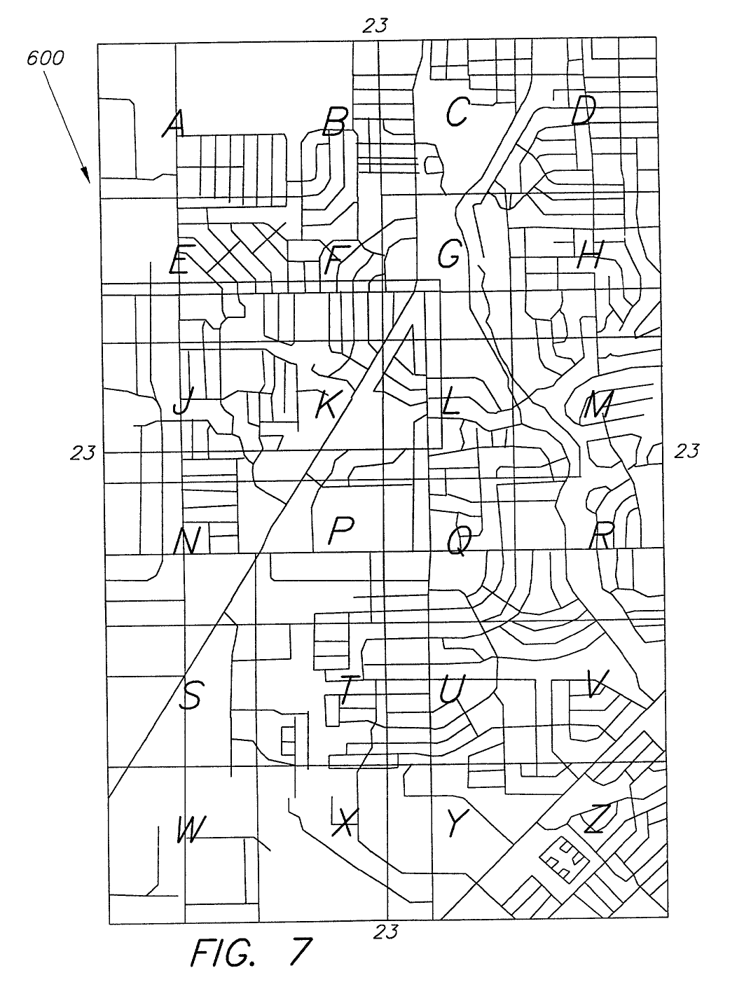

The third step of the preferred method 100 is for entering a set of map, page and grid coordinates 504 for defining a location for the property 130 of interest to a user 80. The coordinates correspond to a map matrix such as the map matrix 600 shown in FIG. 7. The system 10 stores the entered map, page and grid coordinates 504 and map matrix 600 in the data depository 70 for each property. The data repository 70 stores a map matrix 600 for defining a plurality of sectors within a geographical region. FIG. 7 shows a representative illustration of a conventional map matrix 600 commonly used for demarcating a plurality of areas inside a geographical region.

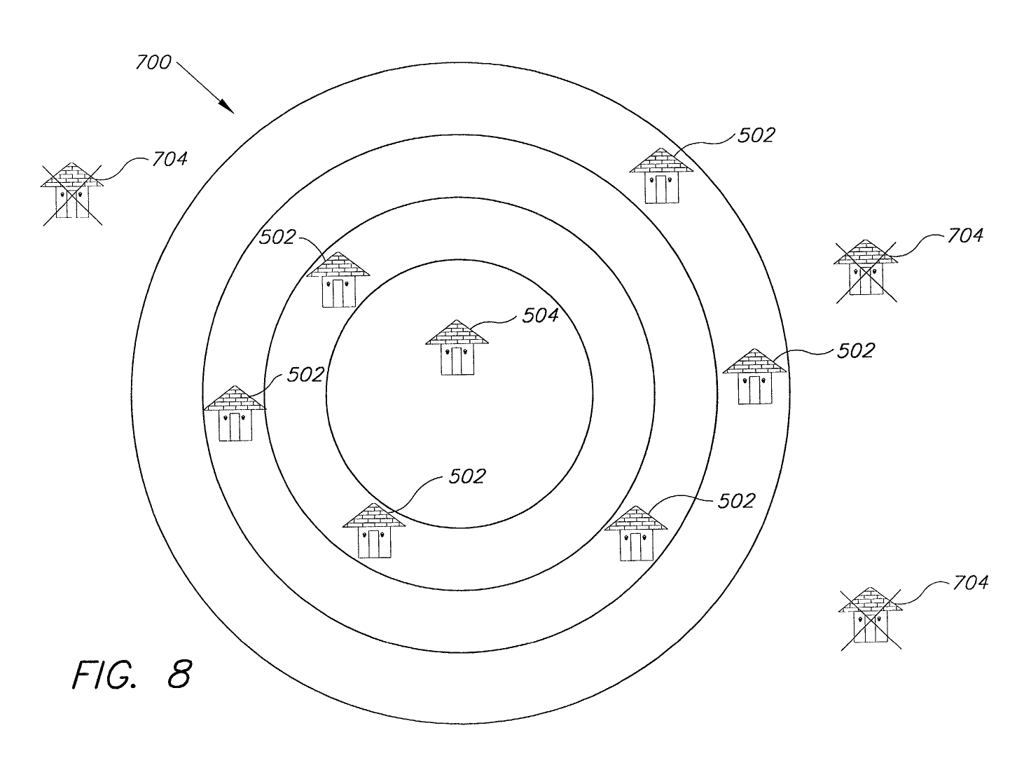

The fourth step of the preferred method 100 is generating a list of additional recorded properties within a predefined radius of the property 140. A sample of property map, page and grid coordinates 504 is illustrated with the previous comps 502 being inside of the radius of the property coordinates 504. The radius is 2.5 miles, and will not include appraisal properties outside the 2.5 mile radius 704. Using the coordinates 504 entered in the previous step 130, the system 10 searches the data repository 70 for comps 502 located within the predefined radius of the coordinates 504. FIG. 8 shows a representative illustration of this.

Based on a comparison of the generated list of properties 704 produced by the system 10 with a current property listing generated by a comparative market analysis and multiple listing service (CMA/MLS), a property owner can make a reasonable assessment of whether the property value of a specified property has changed, by determining if the addresses of the appraisal properties 502 have changed.

For example, suppose the system 10 generated the following list of original appraisal properties (comps) 502 upon entering a set of map and grid coordinates 504 for a particular property of interest:

1. 120 Anystreet Lane,

2. 121 Bobstreet Blvd.,

3. 134 Cherry St. Park,

4. 725 Green St. Ave,

5. 553 Apple Street, and

6. 210 Money Circle.

Furthermore, suppose that an MLS/CMA provider has produced the following list of properties for the area designated by the aforementioned set of map and grid coordinates 504 entered in the system 10.

1. 180 Anystreet Blvd.,

2. 620 Collins St.,

3. 512 Runn Road,

4. 725 Green St. Ave.,

5. 553 Apple St., and

6. 210 Money Circle.

Upon comparing the system's 10 original list to the on-line MLS/CMA list, one may readily notice that 3 of the 6 properties recorded in the system 10 have been replaced by other properties. Such a change in property ownership in the designated area suggests that the property value of the designated property of interest may have changed. According to the present invention, such a finding may be used to make the decision to conduct a new appraisal of the property of interest.

The sixth and seventh steps 160, 170 of the preferred method 100 is to determine whether the initial appraisal value 306 of the property has changed 160 and to update an appraisal value 306 for the property. If a property owner concludes that the appraisal value 306 of the specified property has likely changed, the property owner will update the “Mortgage Loan Balance” field 304 and the current “Appraisal Value” field 306 in the Loan/Value Percentage window 308 shown in FIG. 4.

The eighth step of the preferred method involves printing out a mortgage report, such as a listing of the current loan to value ratio 308 for a mortgage. In the event that the property owner determined that the property value had not changed, then the mortgage report would not be needed since the appraisal had not changed.

Use of the system 10 and method 100 are straightforward. The professionals using the system 10 should have access to all of the information outlined in previous FIGS. 3-6, and should be able to input the information using an Internet 30 connected PC 50. The actual MLS/CMA map and grid coordinates 504 can be acquired and entered into the system 10. As indicated earlier, the information is used to monitor the changing mortgage loan balance to appraisal ratio of a mortgaged property, so a mortgage banker knows when it is time to stop charging the owner for private mortgage insurance (PMI).

It is to be understood that the present invention is not limited to the embodiments described above, but encompasses any and all embodiments within the scope of the following claims.

I claim:

1. A computerized system for calculating a mortgage loan to value ratio, said computerized system comprising:
a firewall which is used to protect the system against external threats coming from the Internet;
a Web server that is accessed by a plurality of client personal computers (PC) via the Internet and Internet service providers (ISP);
a database server that is networked together with the said firewall and said Web server, to store information relating to calculating the mortgage loan to value ratio;
a data repository used to store data that is received from the database server and the Web server; and
a software means for generating a plurality of Web page interfaces on the Web server that clients use to enter and calculate the information relating to the mortgage loan balance to appraisal value ratio.

2. The computerized system according to claim 1, wherein said data repository is a database.

3. The computerized system according to claim 1, wherein said data repository is a mainframe computer.

4. An overall method for calculating a mortgage loan balance to appraisal value ratio for a property, comprising the steps of:
inputting mortgage loan balance and appraisal value data for the property into the system;
calculating the mortgage loan balance to appraisal value ratio for the property;
entering a set of map, page and grid coordinates for defining a geographical location for the property into the system;
generating a listing of additional recorded properties located within a predefined radius of the property;
obtaining a current appraisal value for the property generated by a multiple listing service and comparative market analysis (MLS/CMA);
determining whether the appraisal value of the property has changed;
updating the appraisal value of the property; and
printing a current mortgage loan balance to appraisal value ratio report.

5. The method outlined in claim 4, wherein the appraisal value data for the property, comprises the number of bedrooms, the number of stories, the number of bathrooms, the number of living areas, the number of garages, the number of swimming pools, the number of fireplaces, the total number of square feet and any amenities and comments regarding the property.

6. The method outlined in claim 4, wherein the mortgaged loan balance data for the property, comprises the original loan amount, the monthly loan payment, the private mortgage insurance payment (PMI) payment, the length of the mortgage, the mortgage loan balance, the current home appraised value and the mortgage loan balance to appraisal value ratio.

7. The method outlined in claim 4, wherein basic information relating to the property includes the mortgage owner's first name, last name, street address, city, state, zip code, home telephone number, work telephone number, social security number, date of birth and e-mail address.

8. The method outlined in claim 4, wherein the mortgage loan balance and comparative market analysis are calculated on a periodic basis for enabling the mortgage owner to track the mortgage loan balance to appraisal value ratio for the property over a desired period of time.
